(19) United States
(12) Patent Application Publication
(10) Pub. No.: US 2011/0078566 A1
(43) Pub. Date: Mar. 31, 2011

(54) SYSTEMS, METHODS, TOOLS, AND USER INTERFACE FOR PREVIEWING SIMULATED PRINT OUTPUT

(75) Inventor: WAYNE ROBERTZ, Boulder, CO (US)

(73) Assignee: Konica Minolta Systems Laboratory, Inc.

(21) Appl. No.: 12/571,341

(22) Filed: Sep. 30, 2009

(51) Int. Cl. G06F 17/00; G06F 3/048; H04N 1/60

(52) U.S. Cl. 715/274; 715/856; 715/800; 358/1.9

(57) ABSTRACT

Methods disclosed permit the dynamic previewing of simulation output. In some embodiments, input data may be converted from a first color space to obtain a plurality of downsampled representations of simulation output data in the second color space. A downsampled representation of the simulation output data with a first downsampling factor may be selected so that the first downsampling factor permits display of the entire image in a current size of the display window. Pixels in the input source data can be correlated with pixels in the selected downsampled representation of the simulation output data. At least one pixel in the selected downsampled representation of the print simulation output data may be mapped to a set of pixels in the input data, wherein the number of pixels in the set is determined by the first downsampling factor and one of the pixels in the set can be selected.

### BACKGROUND

1. Field of the Invention

The present invention relates to the field of printing and in particular, to systems, methods, tools, and graphical user interfaces (GUIs) to permit the previewing of simulated print output.

2. Description of Related Art

Modern color printers, which are increasingly common in document processing environments, permit the quick printing of stored documents. Designers of modern printers have focused relentlessly on improving the quality of print output by refining print processing algorithms, enhancing color accuracy, and increasing print throughput, while containing costs. Consequently, consumers have grown accustomed to generating high quality documents even with low cost color printers. Color printer cost can be significantly reduced by shortening the design cycle and permitting newer and more efficient algorithms, or increased functionality to be incorporated quickly into new products.

Design cycle time can be shortened without compromising print quality by using print simulators. Print simulators allow print processing, compression, color conversion and other algorithms to be tested and validated early in the design process. Thus, bugs in algorithms, implementation errors, regression problems, and/or issues with print output quality may be detected early and corrected prior to manufacture.

In print simulators, print processing may be modeled and source bitmap data may be manipulated to produce print output, which can be displayed on a computer monitor, stored in a file, or sent to other programs for analysis. Some print simulators may allow users to compare the output values of specific pixels in the displayed image with source data to determine inaccuracies and flag errors. However, because a typical high resolution print image may consist of several million pixels, the use of print simulators can be cumbersome, and the process is not well-suited to provide dynamic real-time feedback to users as image pixels are traversed. Further, it may be difficult for users to maintain context as they navigate through the millions of pixels in a displayed image. Thus, there is a need for systems, methods, tools, and user interfaces to permit previewing of simulated print output in an intuitive manner.

### SUMMARY

Consistent with embodiments disclosed herein, systems and methods for dynamically previewing simulation output using a graphical user interface comprising a display window are presented. In some embodiments, the method comprises: converting input data from a first color space to obtain a plurality of downsampled representations of simulation output data in a second color space; selecting a downsampled representation of the simulation output data with a first downsampling factor, wherein the first downsampling factor permits display of the entire image in a current size of the display window; correlating at least one pixel in the selected downsampled representation of the simulation output data with at least one pixel in the input data; mapping the at least one pixel in the selected downsampled representation of the print simulation output data to a set of pixels in the input data, wherein the number of pixels in the set is determined by the first downsampling factor; and selecting one of the pixels in the set.

Embodiments also relate to software, firmware, and program instructions created, stored, accessed, or modified by processors using computer-readable media or computer-readable memory. The methods described may be performed on a computer, print controller, and/or a printing device.

These and other embodiments are further explained below with respect to the following figures.

### BRIEF DESCRIPTION OF THE DRAWINGS

FIG. 1 shows a block diagram of an exemplary system for print simulation output previewing consistent with disclosed embodiments.

FIG. 2A shows exemplary source input data in a CMYK color space and exemplary downsampled versions of the input source data in a sRGB color space.

FIG. 2B shows an exemplary mapping of print simulation output data to input source data.

FIG. 3A shows an exemplary image displayed in a GUI associated with an application for print simulation output previewing.

FIG. 3B shows an exemplary image with a zoomed area displayed in a GUI associated with an application for print simulation output previewing.

FIG. 3C shows an exemplary image with a modified zoomed area displayed in a GUI associated with an application for print simulation output previewing.

FIG. 3D shows an exemplary image with exemplary magnifier window and zoom area displayed in a GUI associated with an application for print simulation output previewing.

FIG. 3E shows an exemplary image with exemplary magnifier window displayed in a GUI associated with an application for print simulation output previewing.

FIG. 3F shows an exemplary image with exemplary magnifier window, zoom area, and dynamic control panel displayed in a GUI associated with an application for print simulation output previewing.

### DETAILED DESCRIPTION

In accordance with embodiments disclosed herein, systems and methods to permit simulation output previewing are presented.

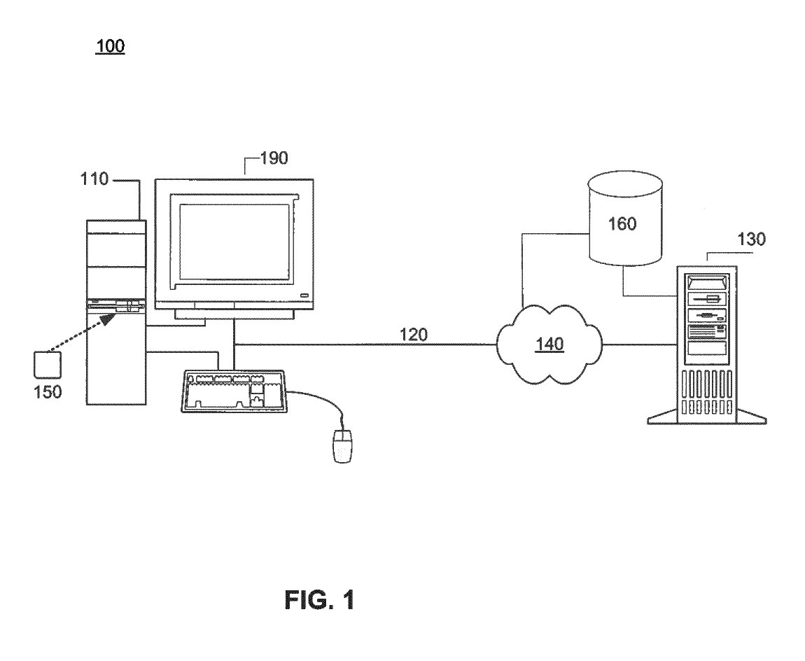

FIG. 1 shows a block diagram of exemplary system 100 for print simulation output previewing. A computer software application for print simulation output previewing may be deployed on a network of computers and/or servers, as shown in FIG. 1, that are connected through communication links that allow information to be exchanged using conventional communication protocols and/or data port interfaces. Print simulation output is produced when a simulator accepts input data in a color space and a color profile as input and produces output data, which can be in another color space.

As shown in FIG. 1, exemplary system 100 includes a computer or computing device 110 and a server 130. Further, computing device 110 and server 130 may communicate over a connection 120, which may pass through one or more networks 140, which could include the Internet. Networks 140 may include subnets, LANs, and/or WANs. Further, network 140 may also include modems, routers, repeaters, and other communication devices (not shown) that permit devices that are coupled to a network 140 to communicate with other devices.

Computing device 110 may be a computer workstation, desktop computer, laptop computer, or any other computing device capable of being used in a networked environment. Server 130 may be a platform capable of connecting to computing device 110 and other devices too (not shown). Computing device 110 and server 130 may include processors that are capable of executing a variety of software applications, such as for print simulation output previewing, print simulators, and other data analysis software.

In one embodiment, server 130 may run applications such as a database management system (“DBMS”) for database 160 that can hold input source data such as source images used by the print simulator. In some embodiments, database 160 may hold raw input source data, as well as one or more downsampled representations of the input source data, and one or more downsampled representations of the output simulation data. Input source data and output simulation data can include bitmap image data.

Downsampling refers to the process of reducing the size of data by selectively filtering out some of the original data. For example, when an image is downsampled, some pixels in the image may be discarded or their component values can be averaged. Downsampling is often performed when image size is decreased. A downsampling factor, which can be an integer or a rational fraction greater than 1, specifies the amount of downsampling. For example, when a bitmap is downsampled by a factor of 8, the downsampled image will have one pixel for every 8×8 pixels in the original bitmap. When a bitmap is downsampled by a factor of 4, the downsampled image will have one pixel for every 4×4 pixels in the original bitmap. A higher downsampling factor produces a smaller image. Thumbnails are examples of images with high downsampling factors.

In one embodiment, server 130 may query database 160 for an appropriate downsampled version of an image depending on the size of the display window in a GUI used to display the print simulation output preview image on monitor 190, which is coupled to computer 110. In one embodiment, the server may select an image with a downsampling factor that is capable of being displayed in its entirety in the display window.

In some embodiments, a correlation may be established between output data generated by a print simulator and the input source data in database 160. Further, information such as cursor position, zoom factor, and/or zoom area pertaining to simulation output data may also be used to query database 160 for input image source data. For example, a database query may be generated using simulation output pixel location information, an area of interest in the simulation output data, a zoom factor, and/or downsampling factor. In one embodiment, an application associated with database 160 may use simulation output pixel location information and the downsampling factor for the currently displayed simulation output to generate a query to retrieve input pixel data corresponding to a specific simulation output pixel. In some embodiments, the downsampled versions of the simulation output data may be generated dynamically in response to user actions in the GUI. For example, a downsampling algorithm may use information provided by the GUI in response to a window resize to compute an appropriate downsampled image and serve the downsampled image to computer 110.

Computing device 110 and server 130 may contain secondary storage, which may include removable media accessed using removable media drive 150. Secondary storage may include one or more hard disks, fixed flash memory, and/or other non-volatile memory. In some embodiments, database 160 may reside on secondary storage coupled to server 130. Removable media drive 150 may include, for example, 3.5-inch floppy drives, CD-ROM drives, DVD ROM drives, CD±RW or DVD±RW drives, USB™ flash drives, Memory Sticks™, Secure Digital High Capacity (“SDHC”) cards, and/or any other removable media drives consistent with disclosed embodiments. Portions of software applications for print simulation output previewing may reside on removable media and be read and executed by computing device 110 using removable media drive 150.

Connection 120 couples computing device 110 and server 130 to network 140. Connection 120 may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB™, SCSI, FIREWIRE™, serial, parallel, and/or BNC ports for transmission of data through the appropriate connection 120. The communication links could be wireless links or wired links or any combination that allows communication between computing device 110 and server 130.

A computer software application for print simulation output previewing may be deployed on exemplary computers 110 and/or server 130 shown in FIG. 1. For example, computing device 110 could provide a user-interface to permit interaction with source image data, which may be stored on database 160 on server 130. In some embodiments, an application for print simulation output previewing may be integrated with a print output simulator to permit seamless pre-viewing of print simulator output and correlation of print simulator output with input source data. In general, applications may execute in whole or in part on one or more computers and servers in system 100. The embodiments described above are exemplary only and other embodiments and implementations will be apparent to one of ordinary skill in the art.

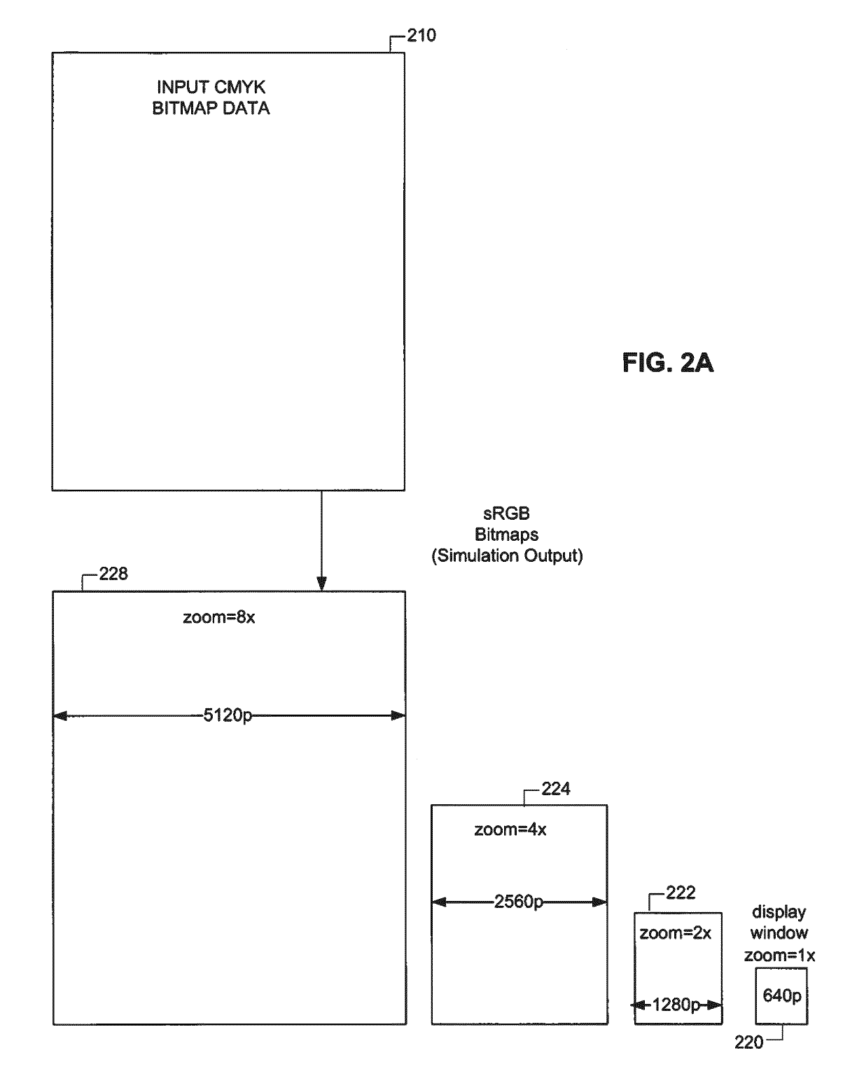

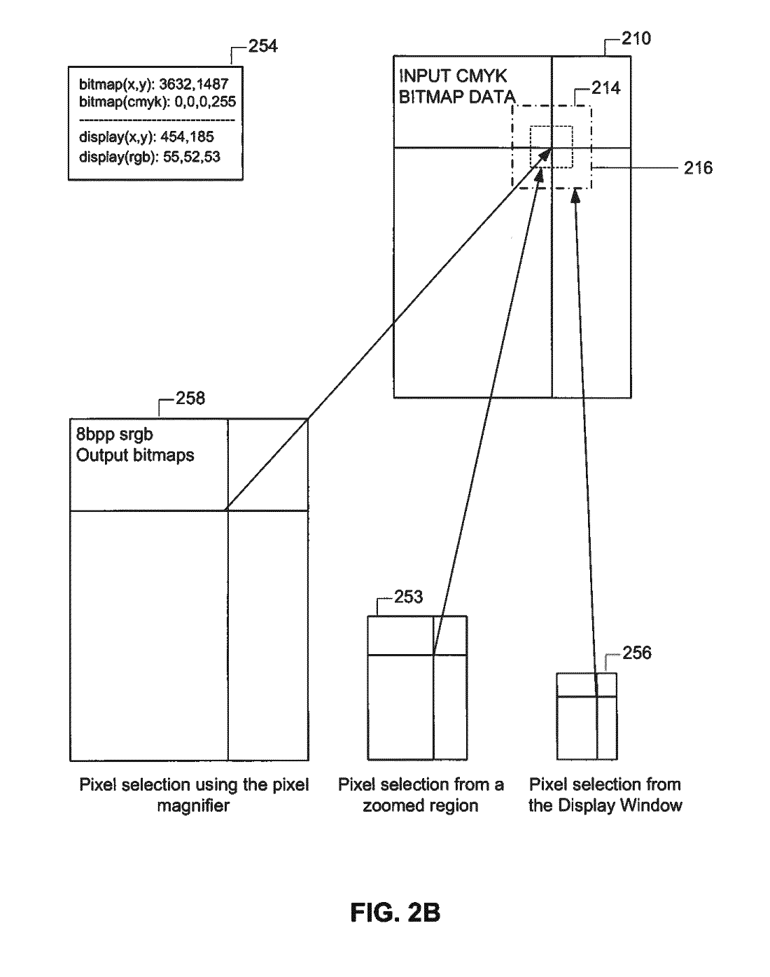

FIG. 2A shows exemplary source input data in a CMYK color space and several exemplary downsampled representations of the input source data in a sRGB color space. Note that the use of CMYK color space for input and the sRGB space for output is exemplary and for descriptive purposes only. In general, input and output data may be in a variety of color spaces and input data in one color space can be converted to output data in a second color space using color profiles. As shown in FIG. 2A, input source data may take the form of input CMYK bitmap data 210. In some embodiments, the input CMYK bitmap data may have 1, 4, or 8 bits per pixel. Accordingly, for a printer with a 600 dots per inch (“dpi”) resolution and a paper size of 8.5 inches, input CMYK data may have 600*8.5=5100 pixels per line, which, in some instances, can be rounded up to 5120 pixels per line. Unlike printers, which use a CMYK color space, monitors, such as monitor 190, and other display devices typically use the RGB color space. Accordingly, in some embodiments, the input CMYK source image may be converted to the sRGB color space using some color profile. In some embodiments, the conversion from the input CMYK color space to the sRGB space may use a profile supplied by a color management system.

As shown in FIG. 2A, the sRGB data may comprise 5120 pixels per line for a zoom factor of 8×. Zoom factors can be calculated based on the size of a standard or default display window. For example, in the embodiment shown in FIG. 2A, the display window is downsampled by a factor of 8 (corresponding to a zoom factor of 1×), i.e. each pixel in the sRGB bitmap for the display window 220 may correspond to 8×8 pixels in input CMYK bitmap data 210. Accordingly, sRGB bitmap for the display window 220 may have 5120/8=640 pixels per line. Similarly, sRGB bitmap 222 for zoom factor=2×(corresponding to a downsampling factor of 2), may have 640*2=1280 pixels per line, while sRGB bitmap 224 for zoom factor=4×(corresponding to a downsampling factor of 2) has 2560 pixels per line and sRGB bitmap 228 for zoom factor=8×(corresponding to a downsampling factor of 1) has 5120 pixels per line.

FIG. 2B shows an exemplary mapping of print simulation output data to input source data. As shown in FIG. 2B, when a simulation output pixel (indicated by crosshair cursor at the intersection of the vertical and horizontal lines) is selected in display window 256, the selected pixel may map to the 8×8 pixel region 216 in input CMYK bitmap data 210, if display window 256 has a downsampling factor of 8. When a pixel is selected in zoomed region 253, then the selected pixel may map to the 4×4 pixel region 214 in input CMYK bitmap data 210, if display window 253 has a downsampling factor of 4. Note that areas 216 and 214 are not to scale and have been enlarged for clarity.

In some embodiments, a single pixel within a region may be identified in input CMYK bitmap data 210 as corresponding to a selected simulation output pixel in a window displaying downsampled data. For example, the center pixel in the region, the highest valued pixel in the region, etc may be selected as corresponding to the selected simulation output pixel. As another example, when a pixel is selected in a pixel magnifier window 258 with an appropriate zoom factor, then the selected pixel may map to a single pixel in input CMYK bitmap data 210.

Exemplary pixel mapping information window 254 may indicate the current x and y coordinates and CMYK values of the pixel in input CMYK bitmap data 210 corresponding to the (x, y) coordinates and sRGB values of the simulation output pixel selected in the display windows. Pixel mapping information window 254 allows users to quickly correlate data in the display window with input CMYK bitmap data 210 and can be updated dynamically as the cursor is moved.

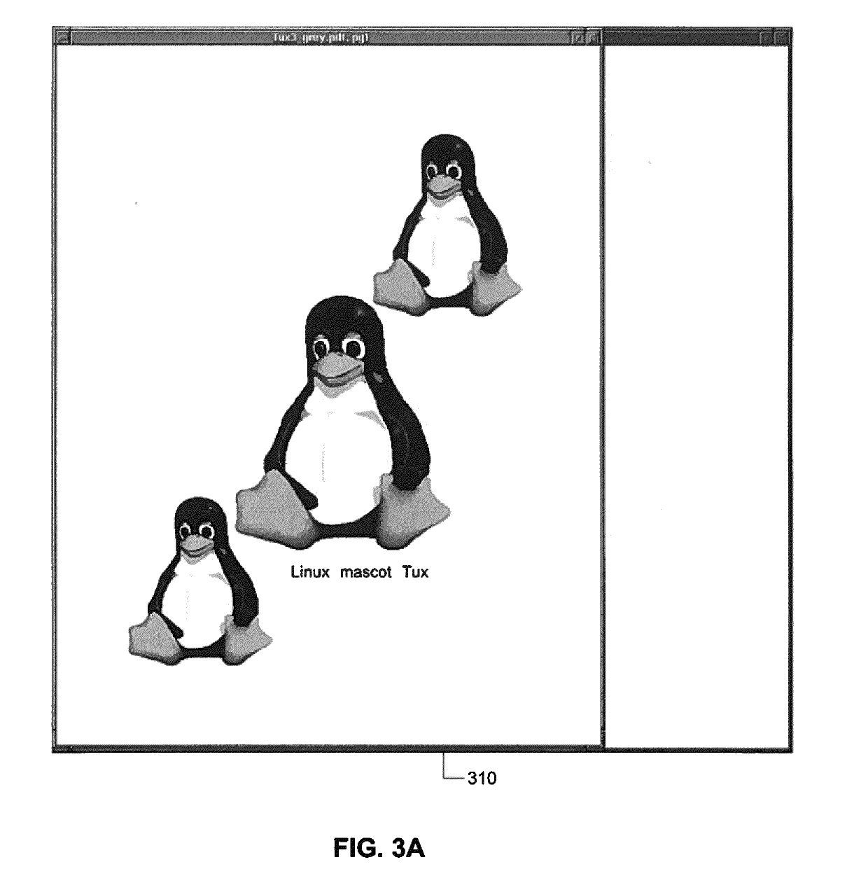

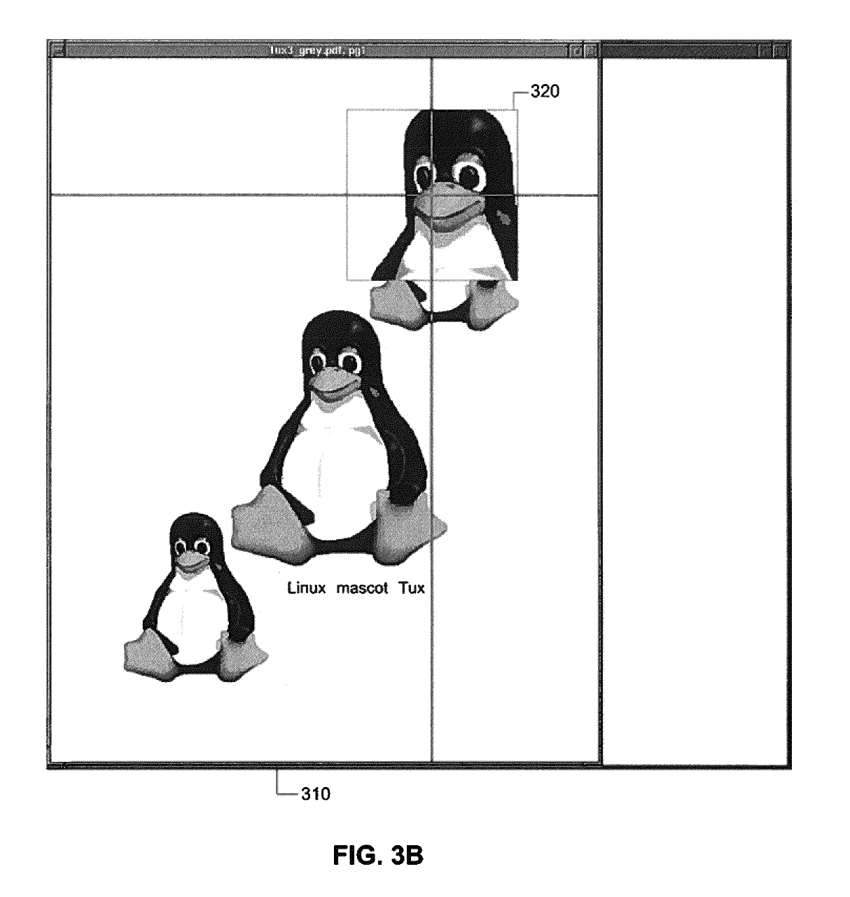

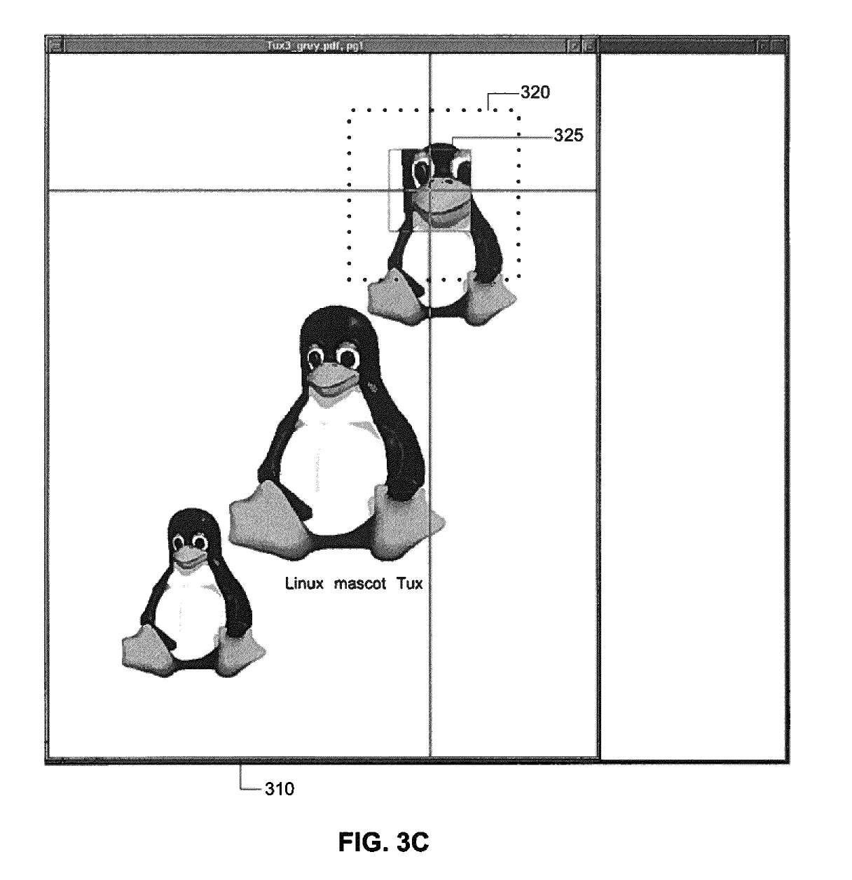

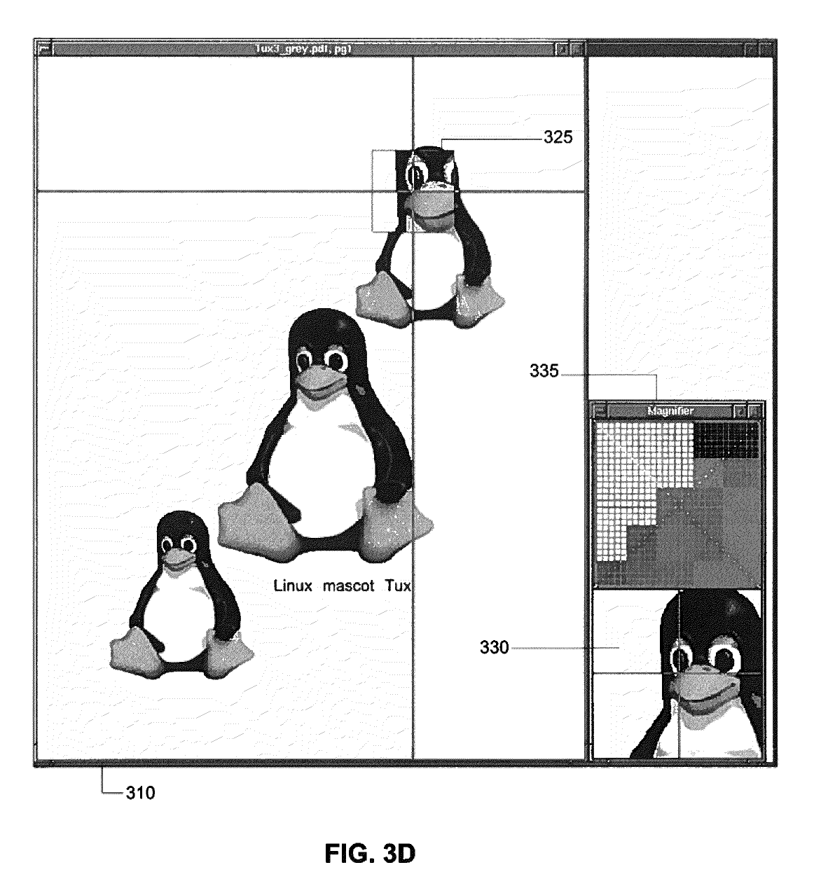

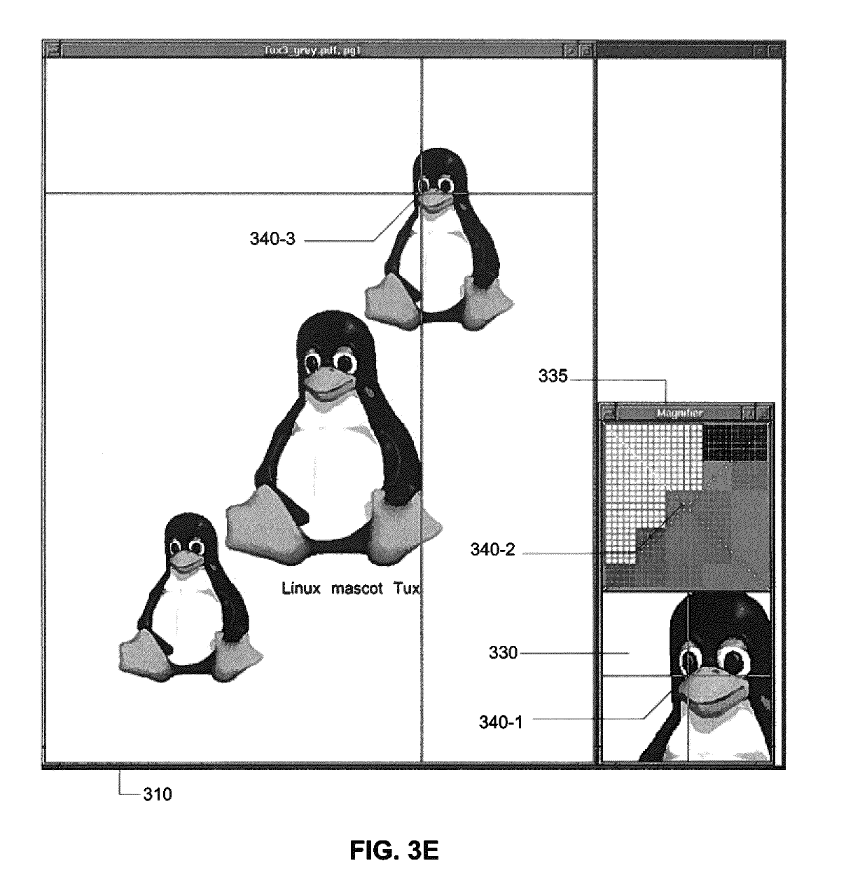

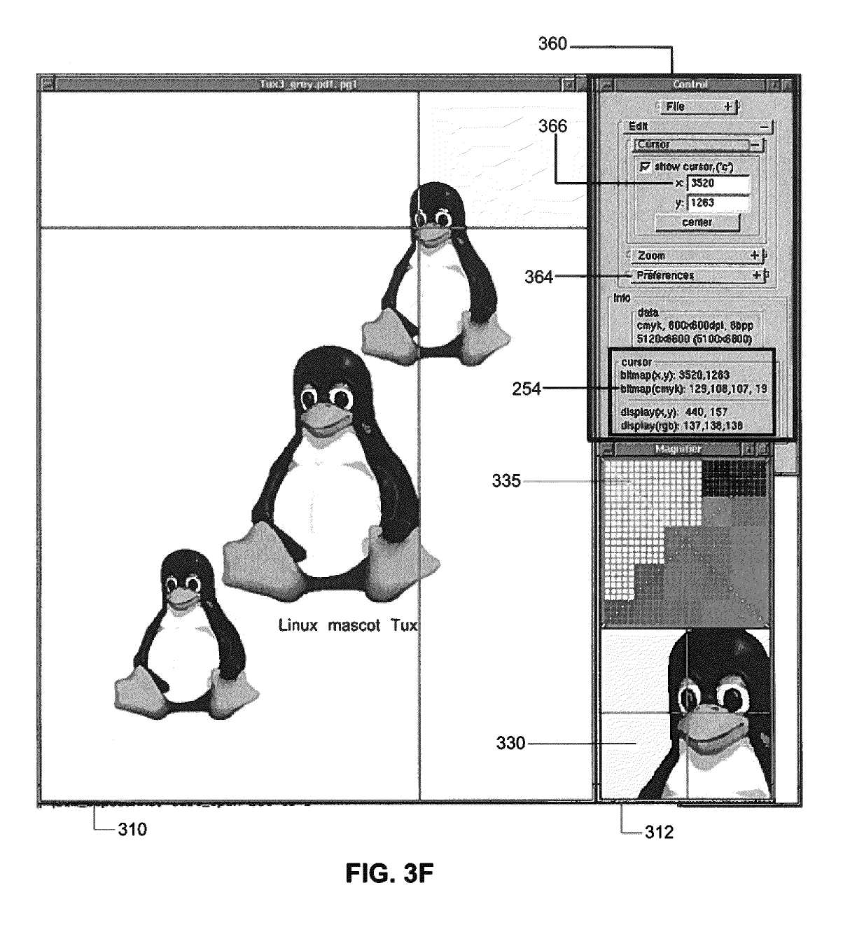

FIG. 3A shows an exemplary image displayed in a GUI associated with an application for print simulation output previewing. The image shown in display window 310 is the Linux mascot Tux. Tux was created by Larry Ewing using the first publicly released version (0.54) of GIMP, a free software graphics package. The image is being used by permission. Note that the image displayed in display window 310 of the GUI may be in the sRGB color space, whereas input CMYK bitmap data 210 may be in the CMYK color space. In some embodiments, print simulation output previewing application can correlate downsampled displayed data with input CMYK bitmap data 210 and permit users to preview output, query individual pixels, toggle individual output channels on or off, and look at magnified portions of the output image. The GUI may also include other windows, which may be used to provide the user with various options, display information related to the output and input image data, and provide other functionality.

A display module associated with an application for print simulation output previewing may convert input data in a first color space to obtain simulation output data in a second color space. The simulation output data may be recursively downsampled to provide numerous representations of the same data at different levels of detail. In one embodiment, the simulation output data can be obtained by converting the native colorspace of the input image data (such as input CMYK bitmap data 210) to the display or output color space (such as sRGB) using an appropriate color profile, which in some instances can be an International Color Consortium (“ICC”) profile. In some embodiments, the plurality of downsampled data planes obtained may be stored in exemplary database 160 on server 130. Then, as the user changes a zoom factor, the appropriate downsampled image can be utilized. In some embodiments, a maximum downsampling factor for a given display window size may be calculated to allow the entire image to be displayed in the display window. Thus, in some embodiments, the downsampled data for a display window can exist from a downsampling factor of 1 (no downsampling) to the maximum downsampling factor calculated above.

FIG. 3B shows an exemplary image with a zoomed area displayed in a GUI associated with an application for print simulation output previewing. As shown in FIG. 3B, a display module associated with a print simulation output previewing application may permit users to create overlaid zoom area 320, which allows for the direct manipulation of a magnified view atop the overall view. That is, zoom area 320 is drawn directly atop the overall view, in the manner that one would use a magnifying glass. In some embodiments, zoom area 320 may move when the cursor is moved. In one embodiment, the user may select a zoom function and click on a location using a mouse or other pointing device in order project a zoomed image in overlaid zoom area 320. Direct manipulation of a magnified view atop the overall view is much more natural and intuitive than indirect manipulation.

FIG. 3C shows an exemplary image with an adjusted zoomed area displayed in a GUI associated with an application for print simulation output previewing. As shown in FIG. 3C, print simulation output previewing application permits users to resize overlaid zoom area. As shown in FIG. 3C, zoomed area 320 has been re-sized to zoomed area 325. In one embodiment, zoomed area 320 may be dynamically re-sized by selecting an edge or corner by activating a mouse button and dragging the edge or corner to the desired location prior to releasing the mouse button. The re-sizing of zoom windows may allow the user to prevent occlusion of areas of the displayed image.

FIG. 3D shows an exemplary image with exemplary magnifier window 335 displayed in a GUI associated with an application for print simulation output previewing. As shown in FIG. 3D, print simulation output previewing application permits users to create a magnified view using zoom area 325. However, in some instances, the use of direct manipulation may occlude portions of the image that are not being magnified. In some embodiments, an alternate zoom area 330 in a separate window may be provided showing the same magnified view as zoom area 325. Further, magnifier window 335 may be used to provide an enlarged pixel view of center of zoom area 330. In some embodiments, magnifier window 335 may show a group of pixels (e.g., 27×27) in a grid to permit individual pixels to be clearly displayed. In some embodiments, pixels may be replicated in the grid for clarity.

FIG. 3E shows an exemplary image with exemplary magnifier window 335 and zoom area 330 displayed in a GUI associated with an application for print simulation output previewing. As shown in FIG. 3E, overlaid zoom areas (such as zoom areas 320 and 325) may be suppressed when zoom area 330 is shown in a separate window. In some embodiments, crosshair cursors 340-1, 340-2, and 340-3 may be displayed, showing the center of magnifier window 335 and zoom area 330 and the corresponding location in display window 310. In one embodiment, the crosshair cursor 340-3 may be moved by an input device, such as a mouse or keyboard keys, and zoom area 330 and/or pixel magnifier area of magnifier window 335 may be scrolled, to indicate a new pixel location. In such cases, corresponding displays of the exemplary image in the other views, as well as the information in control window 360, pixel mapping information window 254 and the pixel location entry fields 366, are all dynamically updated.

FIG. 3F shows an exemplary image with exemplary magnifier window 335, zoom area 330, and control panel 360 displayed in a GUI associated with an application for print simulation output previewing. As shown in FIG. 3F, image data may be manipulated and dynamic feedback of data obtained in all views, including display window 310, zoom area 330, and magnifier window 335. Manipulation of this cursor may be done in any of the three views, typically by moving a mouse or other pointing device. In one embodiment, keyboard arrow keys may also be used to move the cursor and may allow finer control of cursor location and movement. In some embodiments, the cursor may be located specifically by entering bitmap space coordinates in pixel location entry fields 366. Control window 360 may also include information window 254, where pixel location and bitmap color values are dynamically displayed both in the input bitmap's colorspace coordinate system and in the display color coordinate system. In some embodiments, dynamic feedback of data is obtained by looking up input source data (such as input CMYK bitmap data 210) that corresponds to the pixel at the cursor location. Control window 360 may also allow users to select pixel locations, set zoom factors, and set other preferences.

In some embodiments, a program for conducting the processes described above can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A processor implemented method for dynamically previewing simulation output using a graphical user interface comprising a display window, the method comprising:
converting input data in a first color space to obtain a plurality of downsampled representations of simulation output data in a second color space;
selecting a downsampled representation of the simulation output data with a first downsampling factor, wherein the first downsampling factor permits display of the entire image in a current size of the display window;
correlating at least one pixel in the selected downsampled representation of the simulation output data with at least one pixel in the input data;
mapping the at least one pixel in the selected downsampled representation of the print simulation output data to a set of pixels in the input data, wherein the number of pixels in the set is determined by the first downsampling factor; and
selecting one of the pixels in the set.

2. The processor implemented method of claim 1, wherein each of the plurality of downsampled representations of the input data uses a different downsampling factor.

3. The processor implemented method of claim 1, wherein information pertaining to the input data is displayed in conjunction with the display of an image corresponding to the selected downsampled representation of the simulation output data.

4. The processor implemented method of claim 1, wherein a cursor is displayed at a user-selectable location in the display window along with the image corresponding to the selected downsampled representation of the print simulation output data.

5. The processor implemented method of claim 4, wherein the location of the cursor is used to obtain and display information pertaining to at least one input data pixel that correlates with the print simulation output pixel at the cursor location.

6. The processor implemented method of claim 1, wherein the display window comprises a user-selectable zoom area, wherein the zoom area displays an image corresponding to a downsampled representation of the print simulation output data with a second downsampling factor that is not less than the first downsampling factor.

7. The processor implemented method of claim 1, wherein the zoom area is resizable.

8. The processor implemented method of claim 1, wherein the zoom area is displayed on top of the image corresponding to the selected downsampled representation of the simulation output data.

9. The processor implemented method of claim 1, wherein the zoom area is displayed in a separate window that does not occlude any portion of an image corresponding to the selected downsampled representation of the simulation output data that is displayed in the display window.

10. The processor implemented method of claim 6, wherein the graphical user interface further comprises a magnifier window, wherein the magnifier window provides an enlarged view of input data pixels in a user-selectable grid centered on a user-selected simulation output pixel in the zoom area.

11. A computer-readable medium that stores instructions, which when executed by a processor performs steps in a method for previewing simulation output using a graphical user interface comprising a display window, the method comprising:
converting input data in a first color space to obtain a plurality of downsampled representations of simulation output data in a second color space;
selecting a downsampled representation of the simulation output data with a first downsampling factor, wherein the first downsampling factor permits display of the entire image in a current size of the display window;
correlating at least one pixel in the selected downsampled representation of the simulation output data with at least one pixel in the input data;
mapping the at least one pixel in the selected downsampled representation of the print simulation output data to a set of pixels in the input data, wherein the number of pixels in the set is determined by the first downsampling factor; and
selecting one of the pixels in the set.

12. The computer readable medium of claim 11, wherein each of the plurality of downsampled representations of the input data uses a different downsampling factor.

13. The computer readable medium of claim 11, wherein information pertaining to the input data is displayed in conjunction with the display of an image corresponding to the selected downsampled representation of the simulation output data.

14. The computer readable medium of claim 11, wherein a cursor is displayed at a user-selectable location in the display window along with the image corresponding to the selected downsampled representation of the print simulation output data.

15. The computer readable medium of claim 14, wherein the location of the cursor is used to obtain and display information pertaining to at least one input data pixel that correlates with the print simulation output pixel at the cursor location.

16. The computer readable medium of claim 11, wherein the display window comprises a user-selectable zoom area, wherein the zoom area displays an image corresponding to a downsampled representation of the print simulation output data with a second downsampling factor that is not less than the first downsampling factor.

17. The computer readable medium of claim 11, wherein the zoom area is resizable.

18. The computer readable medium of claim 11, wherein the zoom area is displayed on top of the image corresponding to the selected downsampled representation of the simulation output data.

19. The computer readable medium of claim 11, wherein the zoom area is displayed in a separate window that does not occlude any portion of an image corresponding to the selected downsampled representation of the simulation output data displayed in the display window.

20. The computer readable medium of claim 16, wherein the graphical user interface further comprises a magnifier window, wherein the magnifier window provides an enlarged view of input data pixels in a user-selectable grid centered on a user-selected simulation output pixel in the zoom area.

21. A computer-readable memory that stores instructions, which when executed by a processor performs steps in a method for previewing simulation output using a graphical user interface comprising a display window, the method comprising:
converting input data in a first color space to obtain a plurality of downsampled representations of simulation output data in a second color space;
selecting a downsampled representation of the simulation output data with a first downsampling factor, wherein the first downsampling factor permits display of the entire image in a current size of the display window;
correlating at least one pixel in the selected downsampled representation of the simulation output data with at least one pixel in the input data;
mapping the at least one pixel in the selected downsampled representation of the print simulation output data to a set of pixels in the input data, wherein the number of pixels in the set is determined by the first downsampling factor; and
selecting one of the pixels in the set.
